(19) United States
(12) Patent Application Publication
(10) Pub. No.: US 2020/0233980 A1
(43) Pub. Date: Jul. 23, 2020

(54) SECRET INFORMATION GENERATION APPARATUS AND METHOD FOR OPERATING THE SAME

(71) Applicant: ELECTRONICS AND TELECOMMUNICATIONS RESEARCH INSTITUTE, Daejeon (KR)

(72) Inventors: Sang-Jae LEE, Daejeon (KR); You-Sung KANG, Daejeon (KR); Keon-Woo KIM, Daejeon (KR); Byoung-Koo KIM, Daejeon (KR); Ik-Kyun KIM, Daejeon (KR); Ju-Han KIM, Daejeon (KR); Tae-Sung KIM, Daejeon (KR); Mi-Kyung OH, Daejeon (KR); Seung-Yong YOON, Daejeon (KR); Seung-Kwang LEE, Daejeon (KR); Yong-Sung JEON, Daejeon (KR); Doo-Ho CHOI, Cheonan-si (KR)

(21) Appl. No.: 16/742,037

(22) Filed: Jan. 14, 2020

(30) Foreign Application Priority Data
Jan. 23, 2019 (KR) 10-2019-0008764

(51) Int. Cl. G06F 21/72; H04L 9/32

(52) U.S. Cl. CPC G06F 21/72; H04L 9/3271

(57) ABSTRACT

A secret information generation apparatus and a method for operating the secret information generation apparatus. The secret information generation apparatus includes a resistor-capacitor circuit, and a microcontroller unit including a first pin connected to an input terminal of the resistor-capacitor circuit and a second pin connected to an output terminal of the resistor-capacitor circuit, wherein the microcontroller unit is configured to transmit a digital value corresponding to a challenge to the resistor-capacitor circuit through the first pin, receive an output value of the resistor-capacitor circuit corresponding to the digital value through the second pin, convert the received value into a digital value using an analog-to-digital converter, extract one or more valid bits from the converted digital value, and then generate a response.

### CROSS REFERENCE TO RELATED APPLICATION

This application claims the benefit of Korean Patent Application No. 10-2019-0008764, filed Jan. 23, 2019, which is hereby incorporated by reference in its entirety into this application.

### BACKGROUND OF THE INVENTION

### 1. Technical Field

The present invention relates to a secret information generation apparatus and a method for operating the secret information generation apparatus.

### 2. Description of Related Art

With the propagation of technology related to the Internet of Things (IoT), a large number of IoT devices have been developed and sold, and software-based security functions for protecting IoT devices have come to be installed in IoT devices. In particular, individual IoT devices are provided with an encryption key or identification information (ID) that enables unique information thereof to be identified, but, recently, a number of cases where the encryption key or ID is detected using security vulnerabilities and used to launch attacks have been reported. Physically Unclonable Function (PUF) technology, which is technology for generating unique secret information in a semiconductor chip using uncertain characteristics of hardware, may be used to generate and maintain secret information that cannot be known even by semiconductor or device designers. For example, in existing IoT devices, a designer or a seller sets a fundamental ID or a password for setting the corresponding IoT device in the IoT device itself, but, when a PUF is used, a unique ID and a secret key may be generated in the corresponding IoT device itself without requiring these fundamental settings.

### PRIOR ART DOCUMENTS

### Patent Documents

(Patent Document 1) Korean Patent Application Publication No. 10-2018-0125860, Date of Publication: Nov. 26, 2018, Title: Physically Unclonable Function Circuit, System Comprising thereof and Integrated Circuit

(Patent Document 2) Korean Patent Application Publication No. 10-2017-0052506, Date of Publication: May 12, 2017, Title: Apparatus and Method for Generating Identification Key

(Patent Document 3) Korean Patent Application Publication No. 10-2018-0102627, Date of Publication: Sep. 17, 2018, Title: Privacy-Preserving Mutual PUF-based Authentication Protocol

### SUMMARY OF THE INVENTION

Accordingly, the present invention has been made keeping in mind the above problems occurring in the prior art, and an object of the present invention is to provide an apparatus for generating secret information using a resistor-capacitor circuit and an analog-to-digital converter (ADC) and a method for operating the apparatus.

In accordance with an aspect of the present invention to accomplish the above object, there is provided a secret information generation apparatus, including a resistor-capacitor circuit, and a microcontroller unit including a first pin connected to an input terminal of the resistor-capacitor circuit and a second pin connected to an output terminal of the resistor-capacitor circuit, wherein the microcontroller unit is configured to transmit a digital value corresponding to a challenge to the resistor-capacitor circuit through the first pin, receive an output value of the resistor-capacitor circuit corresponding to the digital value through the second pin, and generate a response by converting the received value into a digital value.

In an embodiment, the resistor-capacitor circuit may include one RC filter.

In an embodiment, the resistor-capacitor circuit may include multiple series-connected RC filters.

In an embodiment, each of the first and second pins may include a general purpose input/output (GPIO) pin.

In an embodiment, the microcontroller unit may vary a length of the challenge.

In an embodiment, the microcontroller unit may output the digital value corresponding to the challenge to the resistor-capacitor circuit in one bit at a time during a bit output time.

In an embodiment, the microcontroller unit may determine the bit output time in consideration of charging or discharging of the resistor-capacitor circuit.

In an embodiment, the microcontroller unit may further include an analog-to-digital converter for converting the received value into a digital value.

In an embodiment, the microcontroller unit may extract at least one valid bit from the output value of the analog-to-digital converter, and may determine the extracted valid bit to be the response.

In an embodiment, the microcontroller unit and the resistor-capacitor circuit may be mounted on one printed circuit board (PCB).

In accordance with another aspect of the present invention to accomplish the above object, there is provided a method for operating a secret information generation apparatus, including determining a challenge, a length of the challenge, and a bit output time; outputting a digital value corresponding to the challenge in one bit at a time to the resistor-capacitor circuit through a first pin during the bit output time; receiving the output value of the resistor-capacitor circuit through a second pin; converting the received value into a digital value; extracting at least one valid bit from the digital value; and generating a response using the extracted bit.

In an embodiment, the method may further include checking whether the length of the challenge is ‘0’.

In an embodiment, when the length of the challenge is not ‘0’, the length of the challenge may be decreased by one bit, and outputting the digital value to the resistor-capacitor circuit may be performed.

In an embodiment, a challenge-response pair is determined according to the number of valid bits.

### BRIEF DESCRIPTION OF THE DRAWINGS

The accompanying drawings are provided to aid in understanding of the present embodiments, and the embodiments are provided together with the detailed descriptions thereof. However, the technical features of the present embodiments are not limited to what is specifically shown in the drawings, and the features disclosed in respective drawings may be combined to configure new embodiments.

FIG. 1 is a diagram conceptually illustrating a secret information generation apparatus according to an embodiment of the present invention;

FIG. 2 is a diagram exemplarily illustrating a secret information generation apparatus implemented using an RC filter according to an embodiment of the present invention;

FIG. 3 is a diagram exemplarily illustrating the results of simulation of a secret information generation apparatus configured using a 1-stage RC filter depending on a challenge bit pattern;

FIG. 4 is a diagram illustrating a change in an RC curve depending on a change in the tolerance of an RC circuit implemented using a 1-stage RC filter;

FIG. 5 is a flowchart exemplarily illustrating a method for operating a secret information generation apparatus depending on a challenge according to an embodiment of the present invention; and

FIG. 6 is a diagram exemplarily illustrating an example in which a valid bit is extracted from a read ADC input value.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention.

Reference will now be made in detail to various embodiments of the present invention, specific examples of which are illustrated in the accompanying drawings and described below, since the embodiments of the present invention can be variously modified in many different forms. However, this is not intended to limit the present invention to particular modes of practice, and it is to be appreciated that all changes, equivalents, and substitutes that do not depart from the spirit and technical scope of the present invention are encompassed in the present invention. It will be understood that, although the terms “first” and “second” may be used herein to describe various components, these components should not be limited by these terms. These terms are only used to distinguish one component from another component. For instance, a first component discussed below could be termed a second component without departing from the teachings of the present invention. Similarly, a second component could also be termed a first component. It will be understood that when a component is referred to as being “coupled” or “connected” to another component, it can be directly coupled or connected to the other component, or intervening components may be present therebetween. In contrast, it should be understood that when a component is referred to as being “directly coupled” or “directly connected” to another component, there are no intervening components present.

The terminology used herein is for the purpose of describing particular embodiments only and is not intended to be limiting. In the present invention, the singular forms are intended to include the plural forms as well, unless the context clearly indicates otherwise. It should be further understood that the terms “comprise”, “include”, and “have”, when used in this specification, specify the presence of stated features, integers, steps, operations, elements, components, and/or combinations thereof, but do not preclude the presence or addition of one or more other features, integers, steps, operations, elements, components, and/or combinations thereof. Unless differently defined, all terms used here including technical or scientific terms have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

Physically Unclonable Function (PUF) technology, which generally uses unique characteristics based on hardware, is implemented using an Application-Specific Integrated Circuit (ASIC) or a Field-Programmable Gate Array (FPGA). Among PUF technologies that have been reported to date, PUF technology that uses semiconductor technology may be chiefly classified into arbiter PUF, ring oscillator PUF, and memory-based PUF technologies.

Arbiter PUF is a method for detecting a delay difference in a circuit and generating a random value, and ring oscillator PUF is a method for counting a clock signal generated by an oscillator for a predetermined period of time, comparing the counted clock signal with a certain signal, and then generating random information. Memory-based PUF is a method for extracting a random value from a specific area of memory using a specific method using the characteristics of static random access memory (SRAM), dynamic random access memory (DRAM), or flash memory. Recently, in addition to PUF as described above, research into combined PUF technology in which various types of methods are combined with each other has been conducted. Even if research into various types of PUF technologies is conducted, most PUF technologies must be implemented and installed as separate chips. Due to the characteristics of IoT devices, the IoT devices are inevitably sensitive to price competitiveness, and there is the burden of utilizing an expensive PUF chip or of implementing a separate PUF chip and mounting the separate PUF chip on the corresponding device.

A secret information generation apparatus (or RC PUF) and a method for operating the secret information generation apparatus according to embodiments of the present invention enable the configuration of a PUF using a Resister-Capacitor (RC) element and an Analog-to-Digital Converter (ADC) that can be easily applied to an existing IoT device at low cost.

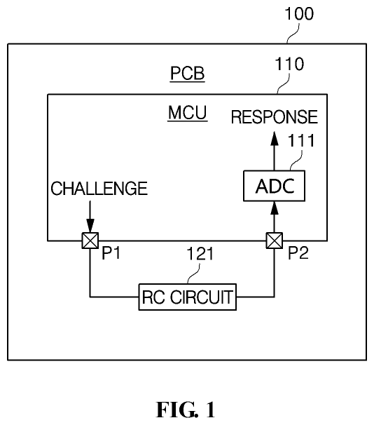

FIG. 1 is a diagram conceptually illustrating a secret information generation apparatus 100 according to an embodiment of the present invention. Referring to FIG. 1, the secret information generation apparatus 100 may include a microcontroller unit (MCU) 110 and an RC circuit 121. The secret information generation apparatus 100 may be mounted on a Printed Circuit Board (PCB). The RC circuit 121, composed of a resistor and a capacitor, is implemented outside a chip for the MCU 110, which is primarily used in IoT devices.

In an embodiment, the secret information generation apparatus 100 may output a digital value corresponding to a challenge to the RC circuit 121 through the first pin P1 of the MCU 110. That is, the RC circuit 121 may continuously receive a bit pattern corresponding to the challenge.

In an embodiment, the secret information generation apparatus 100 may generate an output signal corresponding to the bit pattern corresponding to the challenge having passed through the RC circuit 121, and may transmit the output signal to an ADC 111 through a second pin P2.

In an embodiment, the secret information generation apparatus 100 may generate a response value from a converted value output from the ADC 111.

In an embodiment, the first and second pins P1 and P2 may be implemented as general-purpose input/output (GPIO) pins. However, it should be noted that the present invention is not limited thereto.

In summary, the secret information generation apparatus 100 according to the embodiment of the present invention may generate an arbitrary random response value by allowing a bit pattern corresponding to an arbitrary challenge signal to continuously pass through the RC circuit 121 and by then receiving the final value through the ADC 111 in the MCU 110. Even if identical values are output from the MCU 110, are caused to pass through the RC circuit 121, and are input through the ADC 111, a resistor element and a capacitor element have their own tolerance caused by manufacturing processes. Due to the difference between the characteristics of the ADC 111 provided in the MCU 110 and the difference between the characteristics of PCB patterns, the response signal generated from the ADC 111 may have random characteristics for respective devices.

The secret information generation apparatus 100 using the RC circuit 121 and the ADC 111 according to an embodiment of the present invention may have great differences from elements, structures, operating methods and secret information generation methods used in existing PUFs.

Also, the secret information generation apparatus 100 using the RC circuit 121 and the ADC 111 according to the embodiment of the present invention enables the implementation of a PUF at low cost merely by adding a passive element composed of a resistor and a capacitor to the MCU 110, which is conventionally used, without separately mounting an expensive PUF chip.

Meanwhile, the RC circuit 121 illustrated in FIG. 1 may be implemented as an RC filter.

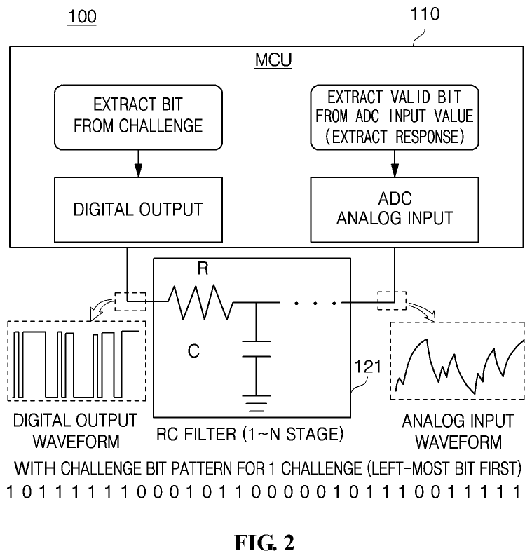

FIG. 2 is a diagram exemplarily illustrating a secret information generation apparatus 100 implemented using an RC filter according to an embodiment of the present invention. Referring to FIG. 2, an RC circuit 121 (see FIG. 1) may include at least one RC filter.

The secret information generation apparatus 100 according to an embodiment of the present invention is a new type of PUF design technology completely different from existing ring oscillator, memory, and a delay-based PUFs. In the secret information generation apparatus 100, an RC filter using one resistor and one capacitor is configured outside the MCU 110 so that the RC filter has one or more stages. Thereafter, bit values corresponding to the challenge bit pattern may be sequentially output through the digital interface of the MCU 110, and may be passed through the RC filter, after which the final output value (analog waveform) of the RC circuit 121 may be read using an ADC 111 (see FIG. 1) provided in the MCU 110, and may be used as a response.

In an embodiment, as illustrated in FIG. 2, while shifting a random challenge bit pattern, such as a digital output waveform, in one bit at a time, the secret information generation apparatus 100 may output the output of the MCU 110 as ‘1’ for a predetermined period time when the corresponding bit is 1, whereas it may output the output of the MCU 110 as ‘0’ for the predetermined period of time when the corresponding bit is ‘0’. Alternatively, output may also be performed in reverse. Here, the predetermined period of time may be set within a full charge or discharge time of the RC circuit 121 determined according to the value of the RC filter. In an embodiment, the predetermined period of time may be determined based on time constant of τ=RC that is set by the RC filter.

Also, the voltage level of the output of the MCU 110 may be determined according to the I/O voltage of the MCU 110. For example, when the GPIO output of the MCU 110 is used as a digital output and the maximum output voltage of the GPIO is 3.3 V, a maximum of 3.3 V may be output if the value of a bit is 1. That is, when the bit to be output is 1, the GPIO output of the MCU 110 may be ‘1’. Accordingly, the output value (ADC input) of the RC circuit 121 may increase for a predetermined period of time based on an RC time constant. If the GPIO output is ‘0’ for a period of time shorter than the full charge time, the output of the RC circuit 121, which is increasing to 3.3 V, may then decrease from an arbitrary increasing value back to ‘0’. When this procedure is repeatedly performed depending on the bit pattern, the final output of the RC circuit 121 may be obtained.

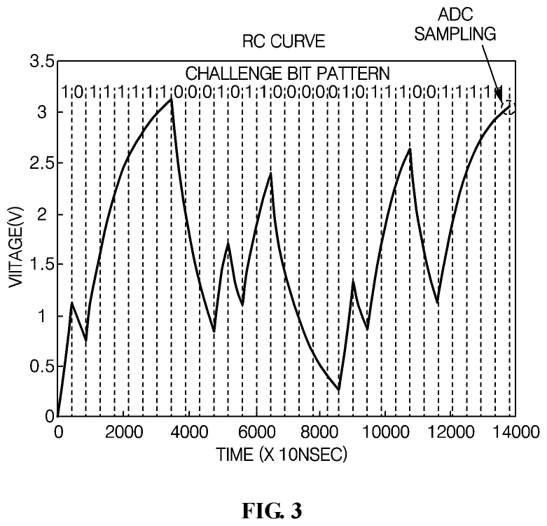

FIG. 3 is a diagram exemplarily illustrating the results of simulation of the secret information generation apparatus 100 configured using a 1-stage RC filter depending on a challenge bit pattern. Referring to FIG. 3, in the case where a challenge bit pattern is [1 0 1 1 1 1 1 1 0 0 0 1 0 1 1 0 0 0 0 0 1 0 1 1 1 0 0 1 1 1 1 1], the results of simulating a change in an RC curve using the 1-stage RC filter circuit composed of one resistor and one capacitor are depicted. During the simulation, a resistor of R=100 KΩ and a capacitor of C=100 pF are used, and the output duration of one bit is 4.3 μsec. As illustrated in FIG. 3, it can be seen that the RC curve changes according to the bit pattern.

Generally, the changes in voltage that generally appear when the RC circuit performs charging and discharging may be represented by the following equations. Here, charging indicates the state of the maximum voltage applied to the input of the RC circuit from ground GND, and discharging indicates the state in which an input makes a transition from the initial input value of the RC circuit to the ground GND.

$${V}_{t} = {V}_{max} ( 1 - {e}^{- \frac{t}{RC}} ) , when rising time$$

$${V}_{t} = {V}_{0} {e}^{- \frac{t}{RC}} , when falling time$$

The secret information generation apparatus 100 according to an embodiment of the present invention may indicate a voltage change corresponding to the state in which an RC input value changes during charging or discharging. For this operation, the equations used for the simulation are modified. The modified equations may include a phenomenon in which charging and discharging start from final voltage values in previous charge and discharge states when an input depending on a new bit is applied to the RC circuit.

$${V}_{t + 1} = {V}_{t} + {V}_{rise} ( 1 - {e}^{- \frac{{T}_{unit}}{RC}} ) , when rising time$$

$${V}_{t + 1} = {V}_{z} {e}^{- \frac{{T}_{unit}}{RC}} , when falling time$$

Here, Vᵣᵢₛₑ=3.3−Vₜ, and the value of Tᵤₙᵢₜ may be 4.3 μsec.

In an embodiment, when the MCU 110 sets the duration per bit to 2 μsec, the processing time of the MCU 110 may be added to the change in the actual waveform, and then Tᵤₙᵢₜ of 4.3 μsec may be reflected in the actual waveform. The value of V₀ at the start point may be 0.

As shown in the above equations, a voltage value rising or falling until a subsequent time is influenced by the value of previous Vₜ. For example, as illustrated in FIG. 3, assuming that 1, 0, and 1 are sequentially applied to the input of the RC circuit in the state in which the input of the RC circuit is 0, and that a digital output voltage is 3.3 V, the voltage change depending on a first value, that is, ‘1’, may be represented by the following equation:

$${V}_{1} = 0 + 3.3 ( 1 - {e}^{- \frac{{T}_{unit}}{RC}} )$$

When a second value, that is, 0, is input, the following equation may be calculated.

$${V}_{2} = {V}_{1} {e}^{- \frac{{T}_{unit}}{RC}}$$

When a third value, that is, ‘1’ is input, the following equation may be calculated.

$${V}_{3} = {V}_{2} + ( 3.3 - {V}_{2} ) ( 1 - {e}^{- \frac{{T}_{unit}}{RC}} ) = {V}_{1} {e}^{- \frac{{T}_{unit}}{RC}} + ( 3.3 - {V}_{1} {e}^{- \frac{{T}_{unit}}{RC}} ) ( 1 - {e}^{- \frac{{T}_{unit}}{RC}} )$$

It can be seen that the influence of previous values is accumulated in the voltage change depending on the input of a new bit pattern. Theoretically, the output values of the RC circuit depending on the same bit pattern must be identical to each other, but a resistor and a capacitor mounted on each board have tolerance in a manufacturing process, and there are differences between the digital output voltages of the MCU or differences between the characteristics of PCB lines and the ADC, and thus the MCU 110 has different RC output values and ADC sample values for respective boards even in the case of the same bit pattern.

The secret information generation apparatus 100 according to the embodiment of the present invention may generate different responses for respective boards for the same challenge using a phenomenon in which the influences of previous values are accumulated in the voltage change depending on the differences in elements or manufacturing processes and depending on the bit pattern.

Meanwhile, since the secret information generation apparatus 100 according to an embodiment of the present invention is influenced by tolerance in the manufacturing process of a resistor and a capacitor, and the output voltage of the RC circuit 121 is influenced by the RC value per bit, as can be seen in the above-described equations, the influence of RC tolerance is accumulated as the number of challenge bits increases, and the final output value of the RC circuit may indicate a meaningful difference to such an extent that a unique value can be extracted for each board.

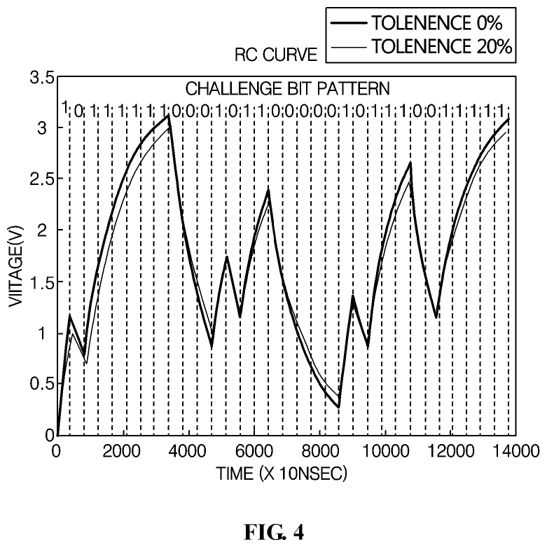

FIG. 4 is a diagram illustrating a change in an RC curve depending on a change in the tolerance of the RC circuit 121 implemented using a 1-stage RC filter. Referring to FIG. 4, since the influence of RC tolerance is accumulated depending on the change in tolerance, a final ADC sampling value may change.

Also, the secret information generation apparatus 100 according to the embodiment of the present invention may freely very the length of a challenge. Therefore, even a long challenge having a length of 32 bits or more may be easily implemented.

Also, the secret information generation apparatus 100 according to the embodiment of the present invention may arrange RC elements constituting the RC filter in multiple stages, so that such tolerance may be further increased, and thus the number of valid bits that are generated may be increased.

Furthermore, in the secret information generation apparatus 100 according to the embodiment of the present invention, a resistor and a capacitor are passive elements having the characteristics of being robust to temperature change. Therefore, when RC elements having excellent temperature characteristics are selected, operating temperature falling within a wide range in conformity with the commercialization of the apparatus may be provided.

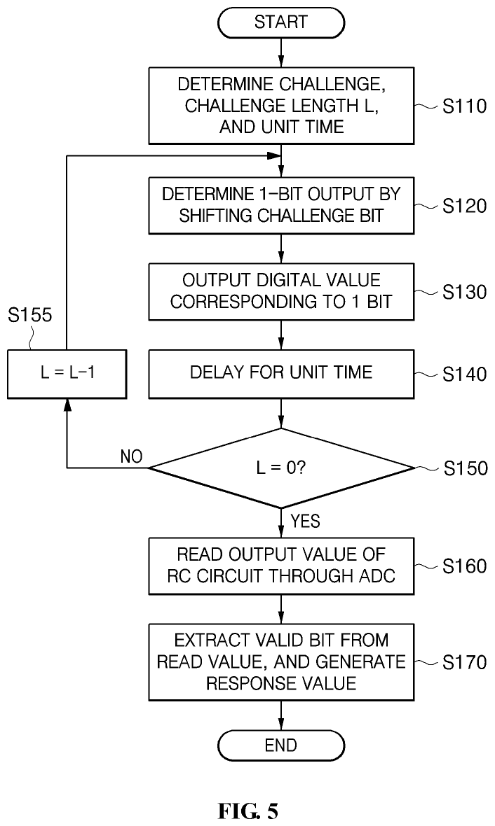

FIG. 5 is a flowchart exemplarily illustrating a method for operating the secret information generation apparatus 100 depending on the challenge according to an embodiment of the present invention. Referring to FIGS. 1 to 5, the method for operating the secret information generation apparatus 100 may be performed as follows.

First, when a challenge is determined and transferred from an upper program, the length L of the challenge and a unit digital output time (i.e., bit output time) to be lasted per unit bit may be determined at step S110. At step S110, the unit digital output time may be equally applied to all bits.

Therefore, depending on the bit pattern of the challenge, 1-bit output (L=L−1) may be determined by left-shifting or right-shifting the challenge at step S120. The value corresponding to the determined bit may be output as a digital value at step S130. For example, when the determined bit is ‘1’, a digital value of ‘1’ may be output (i.e., digital output), whereas when the determined bit is ‘0’, a digital value of ‘0’ may be output, and vice versa.

When the digital output is initiated, the digital output may be maintained (i.e., delayed) during the above-determined unit time at step S140. Thereafter, when the unit time is terminated, whether there are remaining bits without being output, among the bits of the challenge, may be determined. That is, whether the length of the challenge is ‘0’ may be checked at step S150. Here, the unit time may be determined within the range of a full RC charge time or discharge time determined by the values of RC elements.

When the length of the challenge is not ‘0’, the above operation may be repeated on an additional bit through a shift operation at step S155. That is, at step S155, the length of the challenge may be decreased by 1, and then step S120 may be performed.

Thereafter, when the output of all bits has been completed for a single challenge, the output value of the RC circuit may be read through the ADC 111 at step S160. After a valid bit is extracted from the read output value, a response value may be finally generated at step S170.

In accordance with an embodiment, some or all of steps and/or operations may be at least partially implemented or executed using instructions, programs and interactive data structures stored in one or more non-transitory computer-readable storage media, and one or more processors for driving clients and/or servers. The one or more non-transitory computer-readable storage media may be, for example, software, firmware, or hardware, and/or any combination thereof. Also, the function of the term “module” discussed in the present specification may be implemented using software, firmware, hardware and/or combinations thereof.

The one or more non-transitory computer-readable storage media and/or means for implementing/executing one or more operations/steps/modules according to embodiments of the present invention may include, but are not limited to, Application-Specific Integrated Circuits (ASICs), standard Integrated Circuits, controllers which include a microcontroller and execute suitable commands, and/or embedded controllers, Field-Programmable Gate Arrays (FPGAs), Complex Programmable Logic Devices (CPLDs), etc.

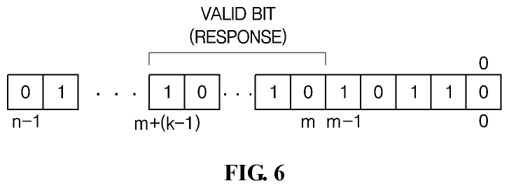

FIG. 6 is a diagram exemplarily illustrating an example in which a valid bit is extracted from a read ADC input value. The length of the read ADC value is determined according to the resolution of an ADC. For example, when the resolution of the ADC is 12 bits, n=4096 is obtained, and several lower bits corresponding to error (tolerance) occurring for the same challenge and tolerance occurring due to a temperature change are removed, and thereafter a response may be generated using 1 to k valid bits.

In an embodiment, the number of bits to be removed may be experimentally set depending on the tolerance of RC elements.

In an embodiment, the length k corresponding to the number of valid bits may be set depending on the tolerance or the like of the RC elements.

Also, once the locations or lengths of valid bits are determined for the same RC elements, the determined values may be equally used without needing to change the valid values at each time for each board since then. For example, when multiple boards are caused to perform an RC PUF operation for the same challenge in order to detect the ADC input values depending on the tolerance in the RC elements, and then the maximum difference between values read through the ADC is 64, m=6 and the lower bits to be removed may be set within the range of 1 to m−1, that is, 1 to 5 bits.

For example, when lower 4 bits are determined to be removed, either or both of a fifth bit and a sixth bit may be used as a valid bit. When two valid bits are used, k may be 2 (k=2).

When only 1 bit is used as a valid bit, k may be 1 (k=1), and a challenge-response pair capable of obtaining a 1-bit response for one challenge may be provided. In this case, when it is desired to obtain secret information having a 128-bit length, secret information may be generated using 128 response bits obtained by operating the RC PUF for 128 different challenges.

When a 2-bit response is obtained for one challenge, results may be obtained by operating the RC PUF for 64 challenges so as to obtain 128-bit secret information.

In accordance with the configuration of the present invention, when the secret information generation method using a resistor-capacitor circuit and an analog-to-digital converter is utilized, existing IoT devices may easily generate secret information at much lower cost without requiring a separate chip, in comparison with conventional schemes. Accordingly, secret key and ID generation methods for IoT devices, the number of which has been gradually increased, may be more effectively secured.

As described above, in accordance with the configuration of the present invention, when the secret information generation method using a resistor-capacitor circuit and an analog-to-digital converter is utilized, existing IoT devices may easily generate secret information at much lower cost without using a separate chip for a secret information generation apparatus, in comparison with conventional schemes. Accordingly, secret key and ID generation methods for IoT devices, the number of which has been gradually increased, may be more effectively secured.

Further, the secret information generation apparatus and the method for operating the secret information generation apparatus according to the embodiment of the present invention may easily implement a long challenge having a length of 32 or more bits by freely changing the length of the challenge.

Furthermore, the secret information generation apparatus and the method for operating the secret information generation apparatus according to the embodiment of the present invention may further increase tolerance and then increase the number of valid bits to be generated by arranging RC elements constituting an RC filter in multiple stages.

Furthermore, the secret information generation apparatus and the method for operating the secret information generation apparatus according to the embodiment of the present invention are characterized in that a resistor and a capacitor are passive elements having the characteristics of being robust to a temperature change. Therefore, when RC elements having excellent temperature characteristics are selected, operating temperature falling within a wide range in conformity with the commercialization of the apparatus may be provided.

Meanwhile, the descriptions of the present invention are only detailed embodiments for practicing the present invention. The present invention may encompass not only detailed and actually available means but also the technical spirit indicating abstract and conceptual ideas that can be utilized as technology in the future.

What is claimed is:

1. A secret information generation apparatus comprising:
a resistor-capacitor circuit; and
a microcontroller unit including a first pin connected to an input terminal of the resistor-capacitor circuit and a second pin connected to an output terminal of the resistor-capacitor circuit,
wherein the microcontroller unit is configured to transmit a digital value corresponding to a challenge to the resistor-capacitor circuit through the first pin, receive an output value of the resistor-capacitor circuit corresponding to the digital value through the second pin, convert the received value into a digital value using an analog-to-digital converter, extract one or more valid bits from the converted digital value, and then generate a response.

2. The secret information generation apparatus of claim 1, wherein the resistor-capacitor circuit comprises one RC filter or multiple series-connected RC filters.

3. The secret information generation apparatus of claim 1, wherein the microcontroller unit varies a length of the challenge.

4. The secret information generation apparatus of claim 1, wherein the microcontroller unit outputs the digital value corresponding to the challenge to the resistor-capacitor circuit in one bit at a time during a bit output time that is determined in consideration of charging or discharging of the resistor-capacitor circuit.

5. A method for operating a secret information generation apparatus, comprising:
determining a challenge, a length of the challenge, and a bit output time;
outputting a digital value corresponding to the challenge to the resistor-capacitor circuit through a first pin in one bit at a time during the bit output time;
checking whether the length of the challenge is ‘0’ after a unit bit output time has elapsed;
when the length of the challenge is not ‘0’, decreasing the length of the challenge by one bit, and outputting a new output value to the resistor-capacitor circuit;
when output of all bits of the challenge is completed, receiving an output value of the resistor-capacitor circuit through a second pin;
converting the received value into a digital value;
extracting at least one valid bit from the converted digital value; and
generating a response using the extracted bit.
